(19) United States
(12) Patent Application Publication
(10) Pub. No.: US 2021/0115952 A1
(43) Pub. Date: Apr. 22, 2021

(54) CLIP

(71) Applicant: Lutech Veterinary Industries, Inc., Ronkonkoma, NY (US)

(72) Inventor: Le Vachula, Ronkonkoma, NY (US)

(73) Assignee: Lutech Veterinary Industries, Inc., Ronkonkoma, NY (US)

(21) Appl. No.: 16/856,397

(22) Filed: Apr. 23, 2020

Related U.S. Application Data
(60) Provisional application No. 62/836,803, filed on Apr. 22, 2019.

(51) Int. Cl. F16B 2/10

(52) U.S. Cl. CPC F16B 2/10

(57) ABSTRACT

The disclosure is directed to a clip. The clip includes an upper jaw, wherein an inner surface of the upper jaw includes a plurality of upper teeth arranged from a proximal end of the upper jaw to a distal end of the upper jaw, a lower jaw, wherein an inner surface of the lower jaw includes a plurality of lower teeth arranged from a proximal end of the lower jaw to a distal end of the lower jaw; and a hinge that rotationally couples the upper jaw to the lower jaw.

### CROSS REFERENCE TO RELATED APPLICATIONS

This application claims the benefit of U.S. Provisional Application No. 62/836,803 filed on Apr. 22, 2019, the entire contents of which is incorporated herein by reference.

### BACKGROUND OF THE DISCLOSURE

Typical clips grip onto something using the inner perimeter of the clip. Usually, it is with the points of a triangular teeth system that extends along an inner perimeter of both jaws of a clip. These teeth cut into whatever the clip grips and can damage or harm the object/subject it is gripping onto. If gripping onto material, the material may be damaged beyond repair. If gripping onto a subject such as human flesh or animal flesh, it may cause injury, pain and result in a long healing period.

What is desired is a system and method that avoids these shortcomings. Embodiments of the present disclosure provide methods that address the above and other issues.

### SUMMARY OF THE DISCLOSURE

The present disclosure is directed to a clip that is used to grip onto objects and subjects. Subjects include any animals, including humans, dogs, cats, etc. The clip includes an upper jaw, wherein an inner surface of the upper jaw includes a plurality of upper teeth arranged from a proximal end of the upper jaw to a distal end of the upper jaw, a lower jaw, wherein an inner surface of the lower jaw includes a plurality of lower teeth arranged from a proximal end of the lower jaw to a distal end of the lower jaw; and a hinge that rotationally couples the upper jaw to the lower jaw.

### BRIEF DESCRIPTION OF THF DRAWINGS

The present disclosure will be better understood by reference to the following drawings of which:

A short description of all figures will be added here.

FIGS. 1-3 are side views of a clip.

FIGS. 4A is top view of the lower jaw of the clip, FIGS. 4B and 4C are side views of a clip including bumpers,

FIGS. 5A-5D are illustrations of variations of individual tooth design.

FIGS. 6A-6E are illustrations of variations of individual tooth design.

FIG. 7 is a rear perspective view of a clip, in an open configuration.

FIG. 8 is a side view of the clip, in a closed configuration,

FIG. 9 is a front perspective view of the clip, in an open configuration.

### DETAILED DESCRIPTION OF THE DISCLOSURE

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

In the discussion and claims herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10%, or any point therein.

As used herein, the term “substantially”, or “substantial”, is equally applicable when used in a negative connotation to refer to the complete or near complete lack of an action, characteristic, property, state, structure, item, or result. For example, a surface that is “substantially” flat would either be completely flat, or so nearly flat that the effect would be the same as if it were completely flat.

As used herein terms such as “a”, “an” and “the” are not intended to refer to only a singular entity, but include the general class of which a specific example may be used for illustration.

As used herein, terms defined in the singular are intended to include those terms defined in the plural and vice versa.

Reference herein to any numerical range expressly includes each numerical value (including fractional numbers and whole numbers) encompassed by that range, To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc. In yet another illustration, reference herein to a range of from “5 to 10” includes whole numbers of 5, 6, 7, 8, 9, and 10, and fractional numbers 5.1, 5.2, 5.3, 5.4, 5.5, 5.6, 5.7, 5.8, 5.9, etc.

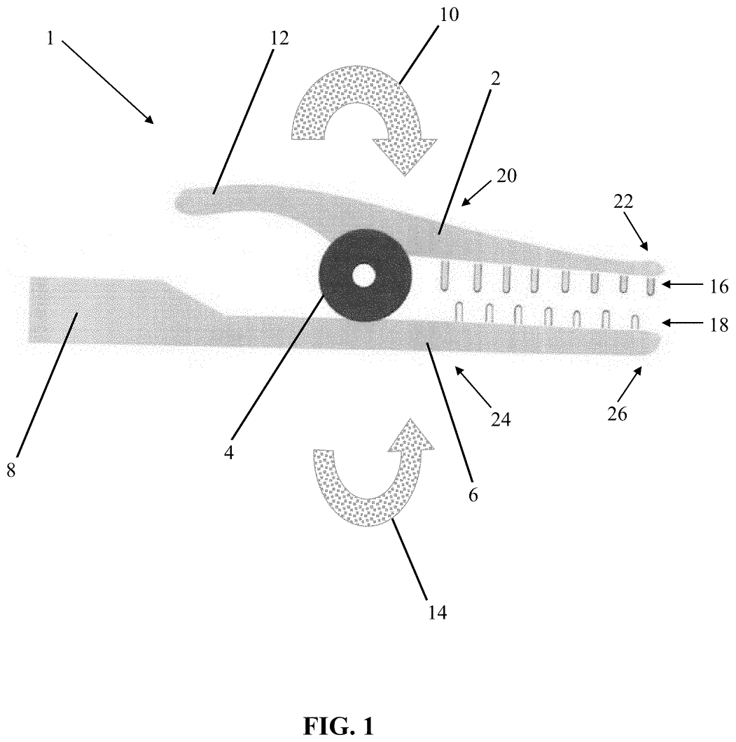

FIG. 1 is a side view of a clip 1 of the present disclosure. The clip 1 includes an upper jaw 2, which is configured to pivot about a hinge 4 with respect to a lower jaw 6. Hinge 4 is illustrated generally as a circle in FIG. 1, but any suitable element that can maintain upper jaw 2 and lower jaw 6 rotatably connected can be hinge 4.

A connector 8 is located in the distal end portion of lower jaw 6 or upper jaw 2 and is configured to electrically and/or mechanically connect the clip 1 with one or more wires and/or cables. The connector 8 can be formed of a single piece of material with the lower jaw 6 or upper jaw 2, or the lower jaw 6 or upper jaw 2 and the connector 8 can be formed of two or more pieces of material. The connector 8 can be various suitable shapes based on the type of component it is to connect to. For example, the connector 8 can be cylindrical to allow a wire and/or cable to be plugged into it and/or the connector 8 can include a snap assembly to allow something to be snapped on to the connector 8.

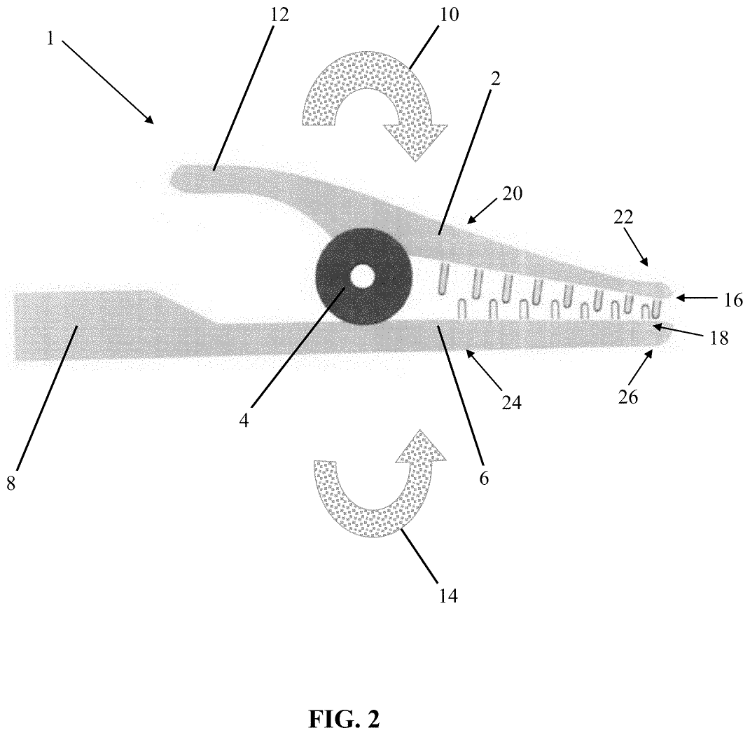

A spring, or other element provides a rotational force to upper jaw 2 in the direction of arrow 10. In order to place the clip 1 in the configuration shown in FIG. 1, a force can be applied to a proximal end 12 of the upper jaw 2, thus applying a rotational force in the direction of arrow 14. In order to place the clip 1 in the configuration shown in FIG. 2, the force is removed from the proximal end 12 of the upper jaw 2, so that the spring (or other element providing rotational force to upper jaw 2) causes upper jaw 2 to rotate in the direction of arrow 10.

Returning to FIG. 1, the upper jaw 2 and the lower jaw 6 can be formed of the same, or of different material, with that material selected from any suitable material, including, but not limited to metals, plastics, ceramics, carbon based materials, and combinations thereof.

On an inner surface of upper jaw 2, a plurality of upper teeth 16, arranged in rows from a proximal end 20 of the upper jaw 2 to a distal end 22 of the upper jaw 2, are included. On an inner surface of the lower jaw 6, a plurality of lower teeth 18, arranged in rows from a proximal end 24 of the lower jaw 6 to a distal end 26 of the lower jaw 6, are included. The number of teeth on either the upper jaw 2 and lower jaw 6, the number of teeth per row, and the number of rows of teeth in either the upper jaw 2 or the lower jaw 6 can vary widely depending on, for example, size of the clip 1, tooth circumference and projected use of the clip 1.

As can be seen in FIG. 1, the length of the successive rows of upper teeth 16, moving from the proximal end 20 of the upper jaw 2 to the distal end 22 of the upper jaw 2, decreases or increases. As can also be seen, the length of the successive rows of lower teeth 18, moving from the proximal end 24 of the lower jaw 6 to the distal end 26 of the lower jaw 6, decreases or creases. This angle of decline or incline may range between about 0° to about 90°, or about 10° to about 80°, about 20° to about 70°, about 30° to about 60°, about 40° to about 50°, or about 45°. As can also be seen the upper teeth 16 are offset horizontally compared to the lower teeth 18, and in this figure, the upper teeth 16 include an additional row of teeth as compared to lower teeth 18, but in other embodiments, lower teeth 18 can have more rows. Another embodiment could have no teeth at all on the upper jaw 2 while having teeth on the lower jaw 6 or no teeth at all on the lower jaw 6 while having teeth on the upper jaw 2.

However, either the upper jaw 2 or the lower jaw 6 may have the additional rows of teeth. All rows of teeth between the upper jaw 2 and the lower jaw 6 may be aligned, or all rows of teeth may be offset, or some rows between the upper jaw 2 and the lower jaw 6 may be offset while other rows are aligned.

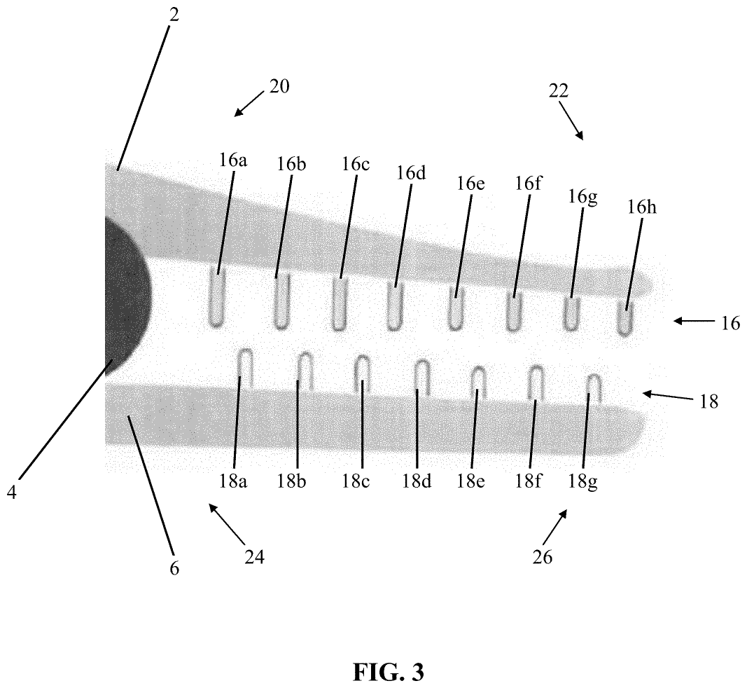

A magnified view of FIG. 1 is shown in FIG. 3. One embodiment of the clip 1 is that the upper teeth 16, moving from proximal end 20 to distal end 22 get successively shorter. For example a tooth 16b is shorter in length than a tooth 16a, a tooth 16c is shorter than a tooth 16b, a tooth 16d is shorter than a tooth 16c, a tooth 16e is shorter than a tooth 16d, a tooth 16f is shorter than a tooth 16e, a tooth 16g is shorter than a tooth 16f, and a tooth 16h is shorter than a tooth 16g. In another embodiment, the upper teeth 16 can all be of the same length. In yet another embodiment, the upper teeth 16, moving from proximal end 20 to distal end 22 get successively longer. In yet another embodiment, the lower teeth 18, moving from proximal end 24 to distal end 26 get successively shorter. In another embodiment, the lower teeth 18 can all be of the same length. In yet another embodiment, the lower teeth 18, moving from proximal end 24 to distal end 26 get successively longer. In other embodiments, either or both of the upper teeth 16 and the lower teeth 18 can include a combination of even length and decreasing/increasing length teeth.

As can be seen the lower teeth 18, moving from proximal end 24 to distal end 26 get successively shorter. For example a tooth 18b is shorter in length than a tooth 18a, a tooth 18c is shorter than a tooth 18b, a tooth 18d is shorter than a tooth 18c, a tooth 18e is shorter than a tooth 18d, a tooth 18f is shorter than a tooth 18e, and a tooth 18g is shorter than a tooth 18f.

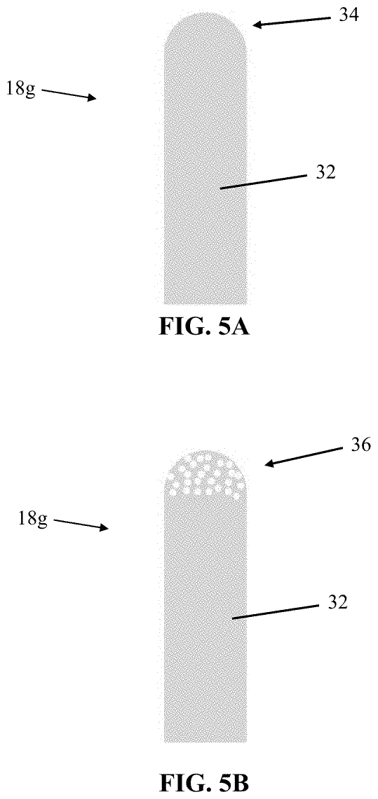

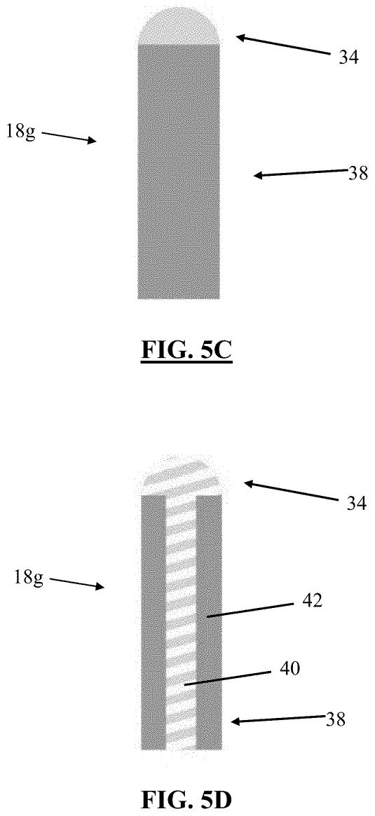

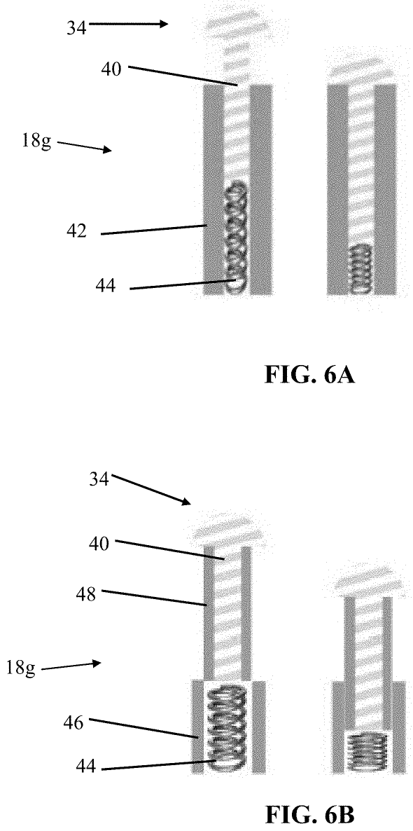

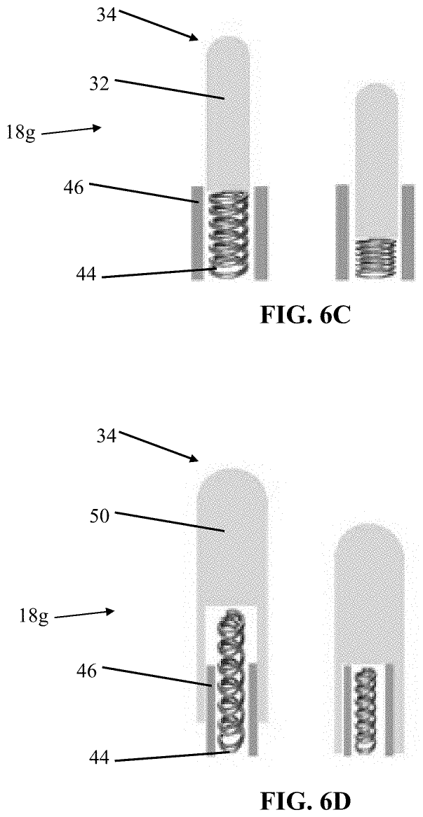

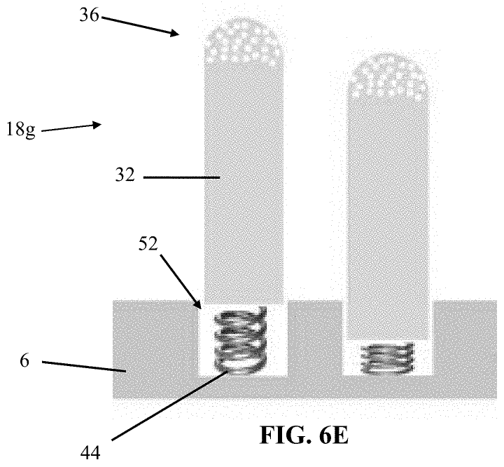

The end surface of each of the teeth can have a substantially circular shape, as shown in FIG. 3, or, the end surface of each of the teeth can be formed from a substantially angled edge and flat end face. The texture of the end surface of each tooth and the side of each tooth may be substantially smooth or substantially rough, or have regions of both. Each individual tooth may include one or more materials. Some examples of such teeth are discussed in more detail in reference to FIGS. 5A-6E below.

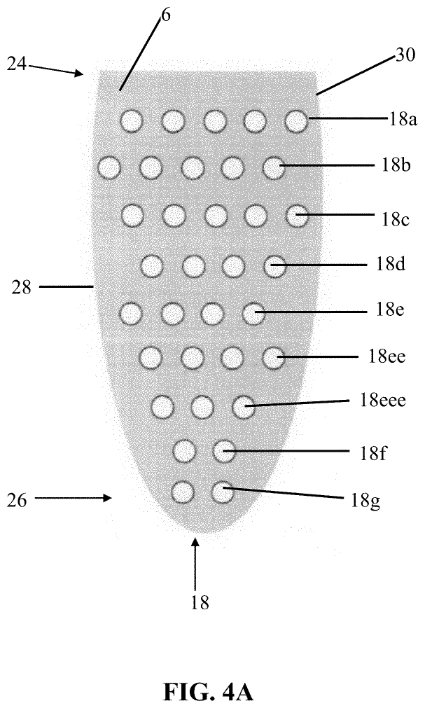

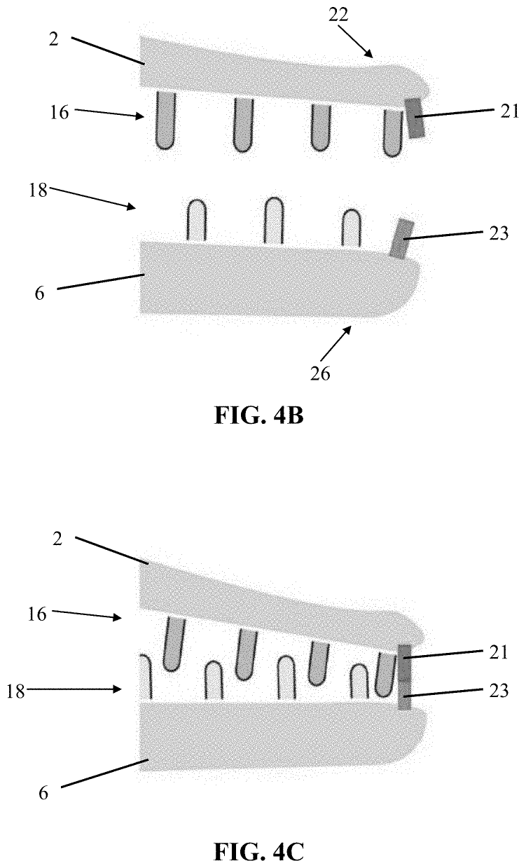

FIG. 4A is a top view of lower jaw 6, with bottom teeth 18. In this view, two additional rows of teeth 18ee and 18eee are included. Although not shown, the upper jaw 2 has a similar distribution of upper teeth 16, which extend from a left edge to a right edge of the upper jaw 2. The total number and distribution of teeth for the upper jaw 2 and the lower jaw 6 can be dependent upon the size and surface area of each jaw, the circumference of each tooth and the use of the clip 1.

As can be seen in FIG. 4A, the teeth of each row, for example teeth 18a extend in a substantially straight line between a left edge 28 towards a right edge 30. The distance between each tooth of each row can be any distance that is larger than the diameter of teeth of the upper jaw 2, so that when the clip 1 is in a closed position, the teeth 18 of the lower jaw 6 have passed the teeth 16 of the upper jaw 2, and vice versa, and the teeth 18 of the lower jaw 6 at least partially contact the upper jaw 2, and the teeth 16 of the upper jaw 2 at least partially contact the lower jaw 6.

In other embodiments, when the clip 1 is in a closed position the teeth 18 of the lower jaw 6 contact at least one or more of the teeth 16 of the upper jaw 2. In this embodiment, the distance between each tooth of each row and each row of teeth themselves can be any suitable distance.

In another embodiment, when the clip 1 is in a closed position, the lower teeth 18 of the lower jaw 6 will not make contact with upper jaw 2 and the upper teeth 16 of the upper jaw 2 will not make contact with the lower jaw 6 due to contact between an upper bumper 21 and a lower bumper 23. Upper bumper 21 is located more distally than the upper teeth 16, at the distal end 22 of the upper jaw 2. Lower bumper 23 is located more distally than the lower teeth 18, at the distal end 26 of the lower jaw 6. Another embodiment of the clip 1 would have no bumpers at all.

Upper bumper 21 and lower bumper 23 can be any suitable length so that their contact can maintain any suitable angle between the upper jaw 2 and the lower jaw 6. For example, as shown in FIG. 4C, the length of the upper bumper 21 and the lower bumper 23 is relatively short, so that the upper teeth 16 nearly contact the lower jaw 6. In other embodiments, the total length of the upper bumper 21 and the lower bumper 23 is relatively longer than what is shown in FIG. 4C so that the upper teeth 16 are further from contacting the lower jaw 6 as compared to the spacing illustrated in FIG. 4C. In other embodiments, the length of the upper bumper 21 and the lower bumper 23 is shorter than what is shown in FIG. 4C, so that upper teeth 16 do contact the lower jaw 6 when the clip 1 is in a closed configuration.

Further, the proximal end of each of the upper bumper 21 and the lower bumper 23 can be any suitable shape or angle.

In other embodiments, only one of the upper bumper 21 and the lower bumper 23 is included, with the single included bumper being of sufficient length to contact the opposing jaw. For example, if only upper bumper 21 were included, it could be of sufficient length as to contact lower jaw 6 before upper teeth 16 contact lower jaw 6.

Also, upper bumper 21 and lower bumper 23 are illustrated as being located at the most distal end of the upper jaw 2 and lower jaw 6. However, in other embodiments, one or both of the upper bumper 21 and the lower bumper 23 can be located along the edges (such as the left edge 28 or right edge 30 of the lower jaw 6 illustrated in FIG. 4A) of one or both of the upper jaw 2 and the lower jaw 6. In another embodiments, one or both of the upper bumper 21 and the lower bumper 23 can be located at the proximal end 24 of the lower jaw 6 or the proximal end 20 of the upper jaw 2. The placement of one or both of the upper bumper 21 and the lower bumper 23 may be located along the edges or somewhere between the left edge 28 and the right edge 30. The placement of the lower bumper 23 may be located anywhere between the proximal end 24 or the distal end 26 of lower jaw 6. The placement of the upper bumper 21 may be located anywhere between the proximal end 20 or the distal end 22 of upper jaw 2. In another embodiment, one or both of the upper bumper 21 and the lower bumper 23 may be placed amongst the teeth.

Each individual tooth of the lower jaw 6 and the upper jaw 2 may be the same as the other, or may be different. Some embodiments of possible individual teeth are discussed below.

FIGS. 5A-5D are cross-sectional illustrations of individual teeth, for example, tooth 18g. In other embodiments, any of the other teeth of either the upper jaw 2 or the lower jaw 6 can be the tooth of these figures.

Tooth 18g includes a shaft 32 that connects to the lower jaw 6 in any suitable way and any suitable angle, and a terminal end surface 34. As an example, the tooth 18g can be angled so that the terminal end surface 34 is further or closer to the proximal end 24 of the lower jaw 6 (and the hinge) as compared to a bottom of the shaft. This angle may range between about 0° to about 90°, or about 10° to about 80°, about 20° to about 70°, about 30° to about 60°, about 40° to about 50°, or about 45°. This angle can apply to any one or more of the other teeth as well, including those on upper jaw 16.1n this embodiment the end surface 34 is substantially smooth and substantially hemispherical.

Another embodiment of tooth 18g is shown in FIG. 5B. FIG. 5B includes a shaft 32 that connects to the lower jaw 6 in any suitable way, and a terminal rough end surface 36. In this embodiment the rough end surface 36 is substantially roughened and/or textured and is substantially hemispherical.

Another embodiment of tooth 18g is shown in FIG. 5C, which is a side view of tooth 18g. In FIG. 5C, the tooth 18g includes the end surface 34 being substantially smooth and substantially hemispherical. Tooth 18g also includes a shaft 38, which is described in more detail in reference to FIG. 5D. FIG. 5D is a cross-sectional view of FIG. 5C illustrating the shaft 38, which includes a hollow, substantially cylindrical external shaft 42 and an inner shaft 40 extending through the external shaft 42 and connected to the end surface 34.

External shaft 42 and internal shaft 40 may be composed of the same, or different materials. Also, one or both of the external shaft 42 and the internal shaft 40 can be fixed to the lower jaw 6.

FIGS. 6A-6E are cross-sectional illustrations of individual teeth in two configurations, for example, tooth 18g. In other embodiments, any of the other teeth of either the upper jaw 2 or the lower jaw 6 can be the tooth of these figures.

In FIG. 6A the right hand side is a compressed configuration of the tooth 18g, while the left hand side figure is an uncompressed configuration of the tooth 18g. In this embodiment, an elastic element 44 is between the internal shaft 40 and the lower jaw 6. The elastic element 44 can be any suitable element that can compress and expand, such as a spring, a piston, and the like. The elastic element 44 allows for the internal shaft 40 to move vertically upwards and downwards if a pressure is applied or removed to the end surface 34. One or both of the elastic element 44 and the external shaft 42 can be fixed to the lower jaw 6.

Another embodiment is shown in FIG. 6B. In FIG. 6B the right hand side is a compressed configuration of the tooth 18g, while the left hand side figure is an uncompressed configuration of the tooth 18g. In this embodiment, a lower external shaft 46 and an upper external shaft 48 can be included, with the upper external shaft 48 able to slide vertically within the lower external shaft 46. The elastic element 44 allows for the internal shaft 40 and the upper external shaft 48 to move vertically upwards and downwards if a pressure is applied or removed to the end surface 34. One or both of the elastic element 44 and the lower external shaft 46 can be fixed to the lower jaw 6.

Another embodiment is shown in FIG. 6C. In FIG. 6C the right hand side is a. compressed configuration of the tooth 18g, while the left hand side figure is an uncompressed configuration of the tooth 18g. In this embodiment a lower external shaft 46 extends around the elastic element 44. The elastic element 44 allows for the internal shaft 32 to move vertically upwards and downwards if a pressure is applied or removed to the end surface 34. One or both of the elastic element 44 and the lower external shaft 46 can be fixed to the lower jaw 6.

Another embodiment is shown in FIG. 6D. In FIG. 6D the right hand side is a compressed configuration of the tooth 18g, while the left hand side figure is an uncompressed configuration of the tooth 18g. In this embodiment a shaft 50 includes a lower portion that circumferentially extends around at least a portion of the elastic element and the lower external shaft 46.

The elastic element 44 allows for the shaft 50 to move vertically upwards and downwards if a pressure is applied or removed to the end surface 34. In a fully compressed configuration the lower portion of the shaft 50 may contact a surface of the lower jaw 6. Also, one or both of the elastic clement 44 and the lower external shaft 46 can be fixed to the lower jaw 6.

Another embodiment is shown in FIG. 6E. In FIG. 6E the right hand side is a compressed configuration of the tooth 18g, while the left hand side figure is an uncompressed configuration of the tooth 18g.

In this embodiment, no external shaft is included, with the elastic element 44 fixed to the lower jaw 6, in a cavity 52 of the lower jaw 6. The elastic element 44 allows for the shaft 32 to move vertically upwards and downwards if a pressure is applied or removed to the rough end surface 36.

Each of the embodiments illustrated in FIGS. 6A-6E allows for one or all of the upper teeth 16 and the lower teeth 18 to move and contour to what is placed between the upper jaw 2 and the lower jaw 6.

In other embodiments, one, two or more of the upper teeth 16 of clip can be selected from the embodiments illustrated in FIGS. 5A-5D, while one, two or more of the other upper teeth 16 of clip 1 can be selected from the embodiments illustrated in FIGS. 6A-6E. In other embodiments, one, two or more of the lower teeth 18 of clip 1 can be selected from the embodiments illustrated in FIGS. 5A-5D, while one, two or more of the other lower teeth 18 of clip 1 can be selected from the embodiments illustrated in FIGS. 6A-6E.

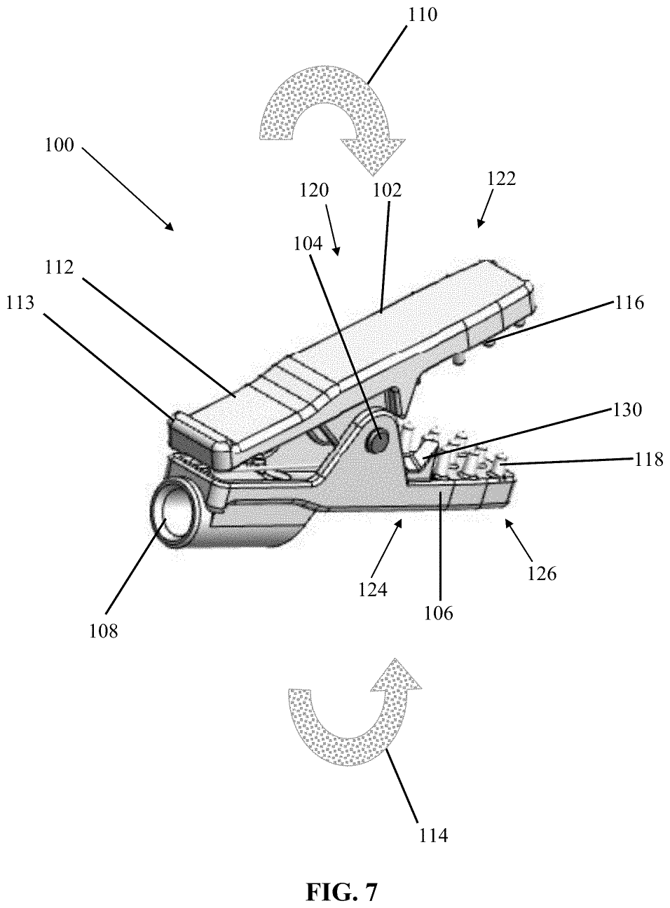

Another embodiment of a clip is shown in FIG. 7, which is a rear perspective view of a clip 100, in an open configuration. The clip 100 includes an upper jaw 102, which is configured to pivot about a hinge 104 with respect to a lower jaw 106. Hinge 104 is illustrated generally as a circle in FIG. 7, but any suitable element that can maintain upper jaw 102 and lower jaw 106 rotatably connected can be hinge 104.

A connector 108 is located in the distal end portion of lower jaw 106 or upper jaw 102 and is configured to electrically and/or mechanically connect the clip 100 with one or more wires and/or cables. The connector 108 can be formed of a single piece of material with the lower jaw 106 or upper jaw 102, or the lower jaw 106 or upper jaw 102 and the connector 108 can be formed of two or more pieces of material.

The connector 108 can be various suitable shapes based on the type of component it is to connect to. For example, the connector 108 can be cylindrical to allow a wire and/or cable to be plugged into it and/or the connector 108 can include a snap assembly to allow something to be snapped on to the connector 108.

In this embodiment, the connector 108 is placed near the hinge 104 (as opposed to further from the hinge) to reduce the overall length of the clip 100, which reduces, during operation, any torque from what is connected to the connector 108 that may cause the clip 100 to twist and/or pull away from the subject.

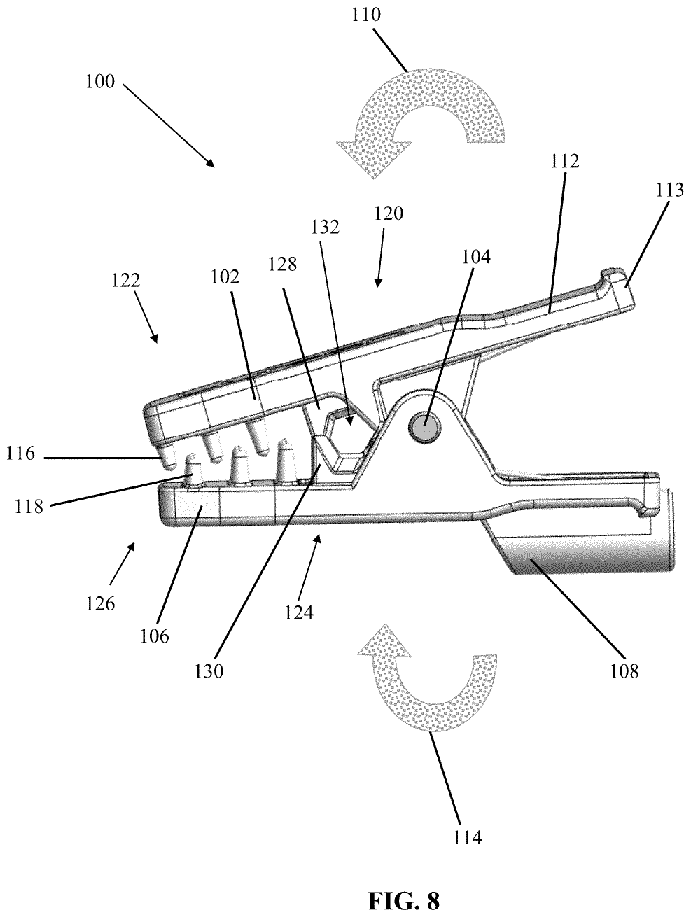

A spring, or other element provides a rotational force to upper jaw 102 in the direction of arrow 110 (these rotational force arrows are also shown in FIG. 8). In order to place the clip 100 in the configuration shown in FIG. 7, a force can be applied to a proximal end 112 of the upper jaw 102, thus applying a rotational force in the direction of arrow 114. In order to place the clip 100 in the configuration shown in FIG. 8, the force is removed from the proximal end 112 of the upper jaw 102, so that the spring (or other element providing rotational force to upper jaw 102) causes upper jaw 102 to rotate in the direction of arrow 110.

Returning to FIG. 7, the proximal end of the jaw 112 includes a proximal end protrusion 113, which extends a portion of the width of the proximal end of the jaw 112 (in this embodiment the entire width of the proximal end of the jaw 112). This proximal end protrusion 113 provides an area of contact for a user's finger, and can reduce the likelihood that the user's finger slides off during operation of the clip 100.

The upper jaw 102 and the lower jaw 106 of clip 100 can be formed of the same, or of different material, with that material selected from any suitable material, including, but not limited to metals, plastics, ceramics, carbon based materials, and combinations thereof.

On an inner surface of upper jaw 102, a plurality of upper teeth 116, arranged in rows from a proximal end 120 of the upper jaw 102 to a distal end 122 of the upper jaw 102, are included. On an inner surface of the lower jaw 106, a plurality of lower teeth 118, arranged in rows from a proximal end 124 of the lower jaw 106 to a distal end 126 of the lower jaw 106, are included. The number of teeth on either the upper jaw 102 and lower jaw 106, the number of teeth per row, and the number of rows of teeth in either the upper jaw 102 or the lower jaw 106 can vary widely depending on, for example, size of the clip 100, tooth circumference and projected use of the clip 100. All rows of teeth between the upper jaw 102 and the lower jaw 106 may be aligned, or all rows of teeth may be offset, or some rows between the upper jaw 102 and the lower jaw 106 may be offset while other rows are aligned. Further, any or all of the upper teeth 116 and the lower teeth 118 can be replaced with any tooth, or pattern of teeth, described in relation to any of FIGS. 1-6E.

The end surface of each of the teeth can have a substantially circular shape, as shown in FIG. 7, or, the end surface of each of the teeth can be formed from a substantially angled edge and flat end face. The texture of the end surface of each tooth and the side of each tooth may be substantially smooth or substantially rough, or have regions of both. Each individual tooth may include one or more materials. Some examples of such teeth are discussed in more detail in reference to FIGS. 5A-6E above.

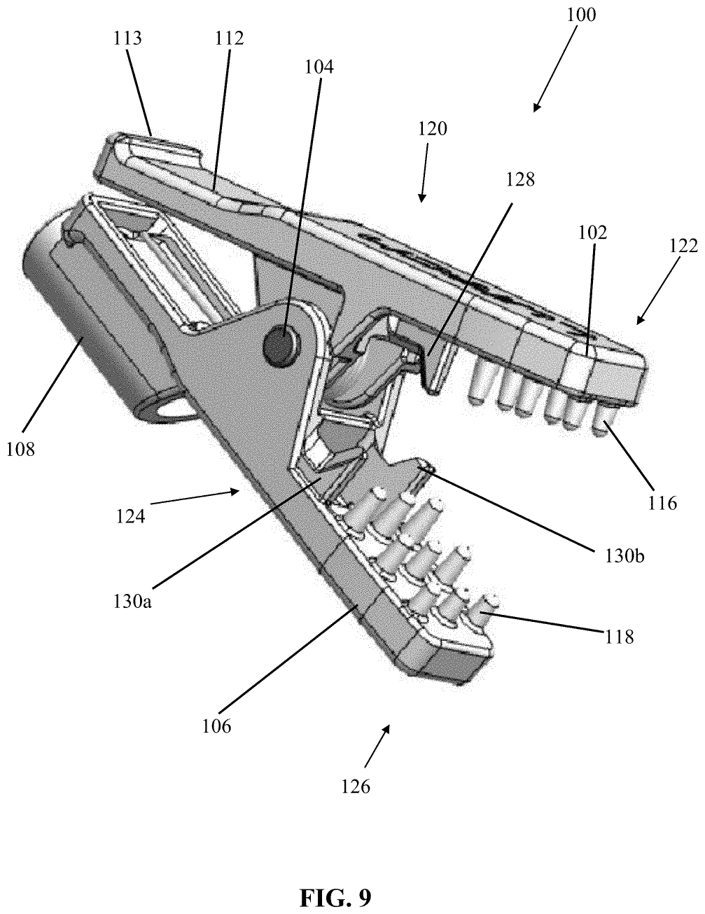

The clip 100 also includes a lower clamp 130 and an upper clamp (not shown in FIG. 7, but viewable in FIGS. 8 and 9).

The lower clamp 130 and the upper clamp 128 are shown in FIG. 8, which is a side view of clip 100. The upper clamp 128 is nearer to the proximal end 120 of the upper jaw 102 than the upper teeth 116. Likewise, the lower clamp 130 is nearer the proximal end 124 of the lower jaw 106 than the lower teeth 118. In this embodiment, the upper clamp 128 can include one, two or more clamp portions (which are better illustrated in FIG. 9), and the lower clamp 130 can include one, two or more clamp portions (which are better illustrated in FIG. 9).

The upper clamp 128 and the lower clamp 130, when the clip 100 is in the closed position (as it is in FIG. 8), form a clamp aperture 132. The clamp aperture 132 is configured to extend around and maintain the position of, relative to the clip 100, elements, such as wires, cables, cords, chains, tubes, etc. This clamp aperture 132. may change in shape depending on the shape and size of the element it would be used to clamp, such shapes to claim include but are not limited to angular elements, substantially circular elements, flat elements, etc.

In the embodiment of the clip 100 illustrated in FIG-, 8, the upper teeth 116, moving from proximal end 120 to distal end 122 get successively shorter. In another embodiment, the upper teeth 116 can all be of the same length. In yet another embodiment, the upper teeth 116, moving from proximal end 120 to distal end 122 get successively longer.

In the embodiment of the clip 100 illustrated in FIG. 8, the lower teeth 118, moving from proximal end 124 to distal end 126 get successively shorter. In another embodiment, the lower teeth 118 can all be of the same length. In yet another embodiment, the lower teeth 118, moving from proximal end 124 to distal end 126 get successively longer. In other embodiments, either or both of the upper teeth 116 and the lower teeth 118 can include a combination of even length and decreasing/increasing length teeth.

A further view of the clip 100, in the open position, is shown in FIG. 9. As can be seen the upper clamp 128 includes a single element that is located about a horizontal center of the upper jaw 102. In this embodiment, the upper clamp is a single element, however, in other embodiments the upper clamp 128 can be two, three, or more upper clamps that can be arranged in an alternating pattern as compared to the pattern of the lower clamp 130.

As can be seen the lower clamp 130 includes two elements (130a and 130b) that are in an alternate position as compared to the upper clamp 128, nearer the horizontal edges of the lower jaw 106. In this embodiment, the lower clamp is a two elements, however, in other embodiments the lower clamp 130 can be one, three, or more lower clamps that can be arranged in an alternating pattern as compared to the pattern of the upper clamp 128. In another embodiment, the upper clam 12.8 and the lower clamp 130 can be aligned. The upper clamp 128 and the lower clamp 130 may be prevented from touching while aligned due to the upper bumper 21 and/or lower bumper 23. In another embodiment, the aligned upper clamp 128 and the lower clamp 130 will touch and may serve as the bumpers and perform the same function as the upper bumper 21 and/or lower bumper 23. In another embodiment, while the upper clamp 128 and lower clamp 130 are in alternating patterns, the upper clamp 128 may touch the bottom of the lower jaw 106, serving the same function as an upper bumper 21 and/or the lower clamp 130 may touch the bottom of the upper jaw 102, serving the same function as a lower bumper 23. In another embodiment, in an alternating pattern, the upper clamp 128 will not touch the upper jaw 102 and the lower clamp 130 will not touch the lower jaw 106.

One use of any of the clips discussed above is in the veterinary field, with a tooth arrangement of the disclosed clips able to be configured to substantially bypass the hair and/or fur of an animal, so that the clip can attach to the skin of the animal, provide sufficient grip to not easily fall off, but exert minimal discomfort to the animal.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

What is claimed is:

1. A clip, the clip comprising:
an upper jaw, wherein an inner surface of the upper jaw comprises a plurality of upper teeth arranged from a proximal end of the upper jaw to a distal end of the upper jaw;
a lower jaw, wherein an inner surface of the lower jaw comprises a plurality of lower teeth arranged from a proximal end of the lower jaw to a distal end of the lower jaw; and
a hinge that rotationally couples the upper jaw to the lower jaw

2. The clip of claim 1, further comprising a connector on a distal end portion of the lower jaw, the connector configured to electrically and/or mechanically connect the clip to at least one of a wire and a cable.

3. The clip of claim 1, wherein the plurality of upper teeth are arranged in successive rows, wherein a length of each tooth of the successive rows of upper teeth, moving from the proximal end of the upper jaw to the distal end of the upper jaw, decreases or increases.

4. The clip of claim 3, an angle of decrease or increases in length, moving from the proximal end of the upper jaw to the distal end of the upper jaw is in a range selected from the group consisting of about 10° to about 80°, or about 20° to about 70°, about 30° to about 60°, and about 40° to about 50°.

5. The clip of claim 1, wherein the plurality of lower teeth are arranged in successive rows, wherein a length of each tooth of the successive rows of lower teeth, moving from the proximal end of the lower jaw to the distal end of the lower jaw, decreases or increases.

6. The clip of claim 5, an angle of decrease in length, moving from the proximal end of the lower jaw to the distal end of the lower jaw is in a range selected from the group consisting of about 10° to about 80°, or about 20° to about 70°, about 30° to about 60°, and about 40° to about 50°.

7. The clip of claim 1, wherein an end surface of each of the plurality of upper teeth, and an end surface of each of the plurality of lower teeth, have a shape selected from the group consisting of a substantially circular shape, a substantially angled edge and a flat end face,

8. The clip of claim 1, wherein the upper jaw further comprises an upper bumper, wherein the upper bumper is located on the inner surface of the upper jaw.

9. The clip of claim 8, wherein the lower jaw further comprises a lower bumper, wherein the lower bumper is located on the inner surface of the lower jaw.

10. The clip of claim 9, wherein in a closed configuration of the clip, the upper bumper and the lower bumper contact each other.

11. The clip of claim 10, wherein none of the plurality of lower teeth contact the upper jaw, and none of the plurality of upper teeth contact the lower jaw.

12. The clip of claim 1, wherein at least one tooth of the plurality of upper teeth and/or at least one tooth of the plurality of lower teeth comprises a shaft that connects to the respective upper jaw and/or lower jaw, wherein the shaft comprises and a terminal end surface, wherein the terminal end surface is selected from the group consisting of a rough surface and a smooth surface.

13. The clip of claim 1, wherein at least one tooth of the plurality of upper teeth and/or at least one tooth of the plurality of lower teeth comprises a shaft, the shaft comprising a hollow, substantially cylindrical external shaft and an inner shaft extending through the external shaft, wherein an end surface of the inner shaft is exposed from the external shaft.

14. The clip of claim 13, further comprising an elastic element between, and connected to, the inner shaft and the lower jaw or upper jaw.

15. The clip of claim 1, further comprising a proximal end protrusion that extends at least a portion of a width of the upper jaw, wherein the proximal end protrusion is configured to provide an area of contact for user's finger.

16. The clip of claim 1, further comprising an upper clamp that ends from the surface of the upper jaw and is nearer to the proximal end of the upper jaw than the plurality of upper teeth, and a lower clamp that extends from the surface of the lower jaw and is nearer to the proximal and of the lower jaw than the plurality of lower teeth.

17. The clip of claim 16, wherein, in a closed configuration of the clip, the upper clamp and the lower clamp form a clamp aperture that is configured to extend around and maintain the position of, relative to the clip, a element selected from the group consisting of a wire, a cable, a cord, a chain, and a tube.

18. The clip of claim 16, wherein the lower clamp comprises two lower clamps that are arranged in an alternate position on the lower jaw as compared a position of the upper clamp on the upper jaw.

19. The clip of claim 16, wherein the lower clamp and the upper clamp are composed of the same number of clamps and are aligned.

20. The clip of claim 1, wherein a terminal end surface of at least one tooth of the plurality of upper teeth and/or at least one tooth of the plurality of lower teeth is nearer or farther than a base of the at least one tooth from the hinge, so that the at least one tooth is angled in a range selected from the group consisting of about 0° to about 90°, of about 10° to about 80°, or about 20° to about 70°, about 30° to about 60°, and about 40° to about 50°.
